(19) United States
(12) Patent Application Publication
(10) Pub. No.: US 2003/0133437 A1
(43) Pub. Date: Jul. 17, 2003

(54) Digital subscriber line feature for enabling plain old telephone service on digital lines in the event of a power failure

(76) Inventors: John William Richarson, Hamilton, NJ (US); Kumar Ramaswamy, Plainsboro, NJ (US); Thomas Anthony Stahl, Indianapolis, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/043,469

(22) Filed: Jan. 11, 2002

(51) Int. Cl. H04L 12/66; H04L 12/28

(52) U.S. Cl. 370/352; 370/400

(57) ABSTRACT

An apparatus and method for maintaining service on a digital subscriber line are described. An analog service system, which provides analog service with a battery back-up capable of delivering power during a power outage and a digital service unit coupled to the analog service system are included. The digital service system provides digital service to a user. A relay is coupled to the analog service system and the digital service unit to selectively enable a service line with analog service or digital service responsive to a power outage event. Service is switched digital to analog during the power outage event.

### FIELD OF THE INVENTION

The present invention generally relates to network communications and, more particularly, to a method and apparatus for providing continued telephone service from a voice-enabled modem in the event of a power failure.

### BACKGROUND OF THE INVENTION

Voice over digital subscriber line (VoDSL) is a broadband service that makes use of digital subscriber line's (DSL's) data transport capabilities and permits multiple voice lines and data to be simultaneously transmitted over a single existing copper wire. VoDSL is rapidly becoming an important DSL application, with potential in service revenues expected to reach billions of dollars in a few years.

The capability for carrying both broadband and voice over the same DSL lines is very advantageous. The power grid of a local utility typically powers current DSL modems at the customer's location or other locations, while portions of the DSL system at the head-end (or at the phone company) are powered by DC batteries. Accordingly, in the event of a power failure, DSL service is typically unavailable at customer locations. This creates difficulties especially for VoDSL, where calls are terminated as a result of a power failure.

Plain Old Telephone Systems (POTS) at the customer premises is powered by the network. In the event of a power failure, POTS continues to function because network equipment has battery backup power. However, DSL equipment in the home cannot be powered by the network due to the much greater power requirements needed to operate a DSL modem. So, in a service terminated at the home, while POTS service will still be available in the event of a power failure, all DSL related services are not available. For voice services that are carried over the DSL link, there is a need to switch the voice services to a POTS service in the event of a power failure.

Therefore, a need exists for a method and apparatus, which provides continued voice service over DSL lines in the event of a power failure.

### SUMMARY OF THE INVENTION

A method for maintaining phone service on a digital subscriber line during a power failure or other event includes the steps of providing a voice over digital subscriber line (VoDSL) for transmission of information and an analog service, which employs a battery power back-up system. The VoDSL is switched to the analog service in the event of a power outage to maintain telecommunication service of the VoDSL during the power outage. This switching is preferably intelligently done so that even after power-up the calls in progress remain uninterrupted.

An apparatus for maintaining phone service on a digital subscriber line includes an analog service system, which provides analog service with a battery back-up capable of delivering power during a power outage and a digital service unit coupled to the analog service system. The digital service system provides digital phone service to a user. A relay is coupled to the analog service system and the digital service unit to selectively enable a service line with analog phone service or digital phone service responsive to a power outage event.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary digital subscriber line (DSL) system architecture capable of offering integrated multi-line telephony services such as voice, data and video and showing a customer premise unit having intelligent switching capability in accordance with the present invention;

FIG. 2 is a block diagram of an illustrative customer premise unit having a bank of relays for performing switching in accordance with the present invention;

FIG. 3 is a block diagram of an illustrative POTS splitter employed in accordance with one embodiment of the present invention;

FIG. 4 is a block diagram showing illustrative relay circuitry for performing intelligent switching in accordance with the present invention; and

FIG. 5 is a flow diagram showing steps for maintaining voice service during a power outage in accordance with the present invention.

It should be understood that the drawings are for purposes of illustrating the concepts of the invention and are not necessarily the only possible configuration for illustrating the invention.

### DETAILED DESCRIPTION OF THE INVENTION

The present invention provides a method and apparatus for improving voice over digital subscriber line service (VoDSL). In preferred embodiments, this may be provided by switching over all or some VoDSL lines to plain old telephone service (POTS) in the event of a power failure. In this way, voice transmission services over a POTS/DSL line will continue to be provided during a power failure. In addition, the present invention provides for the uninterrupted continuation of voice transmissions when the power is restored.

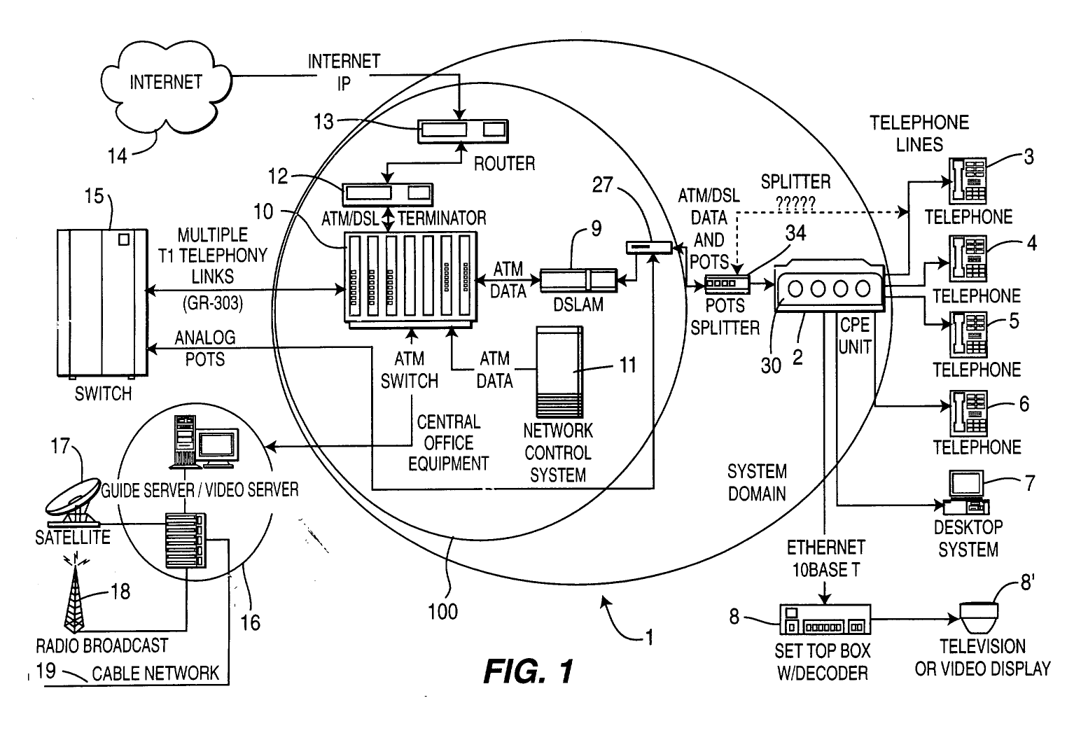

Referring now in specific detail to the drawings in which like reference numerals identify similar or identical elements throughout the several views, and initially to FIG. 1, a DSL system architecture 1 for integrating voice, data and video services is shown. System architecture 1 is presented as an exemplary DSL environment for employing the inventive method and apparatus in accordance with the present invention. Details of the individual block components making up the system architecture are known to skilled artisans, and will only be described in details sufficient for an understanding of the present invention. The system block diagram 1 is composed of several functional blocks. The system domain is composed of Central Office (CO) Equipment 100 and Customer Premise Equipment (CPE) 2. The component blocks within the system domain and their respective interfaces are: customer premise equipment (CPE), Digital Subscriber Line Access Multiplexer (DSLAM) 9, an ATM switch 10, an Internet protocol (IP) router 13, POTS splitter rack 27, DSL terminator 12, and a network control system (NCS) 11.

One illustrative set-up for customer premise equipment (CPE) 2 includes, for example, a DSL modem unit 30. CPE 2 interfaces with analog telephones (for example, analog telephones 3, 4, 5 and 6) employing VoDSL service, a 10Base-T Ethernet connection to a PC desktop system 7, and an Ethernet or RS-422 connection to a set-top box with a decoder 8 for connection to, for example, a television or video display 8′. Under normal operation, from the customer's analog end, the CPE device 2 accepts the analog input from each of the telephones 3-6 converts the analog input to digital data, and packages the data into ATM packets (Voice over ATM), with each connection having a unique virtual channel identifier/virtual path identifier (VPI/VCI). Known to skilled artisans, ATM is a connection-oriented protocol and as such there is a connection identifier in every cell header, which explicitly associates a cell with a given virtual channel on a physical link. The connection identifier includes two sub-fields, the virtual channel identifier (VCI) and the virtual path identifier (VPI). Together these identifiers are used for multiplexing, demultiplexing and switching a cell through the network. VCIs and VPIs are not addresses, but are explicitly assigned at each segment link between ATM nodes of a connection when a connection is established, and remain for the duration of the connection. When using the VCI/VPI, the ATM layer can asynchronously interleave (multiplex) cells from multiple connections.

The Ethernet data is also encapsulated into ATM cells with a unique VPI/VCI. The ATM cell stream is sent to the DSL modem to be modulated and delivered to the DSLAM unit 9.

The DSL signal is received and demodulated by the DSL modem 30 in the customer premise equipment 2 and delivered to VPI/VCI detection processing. The ATM cell with VPI/VCI matching that of the end user's telephone is then extracted and converted to analog voice to be delivered to the telephone.

Analog POTS is provided through switch 15 and sent through a POTS splitter rack 27, which places analog service on the same line from Digital Subscriber Line Access Multiplexer (DSLAM) 9, which includes digital service. Rack 27 includes one or more POTS splitters (similar to POTS splitter 34) employed at central office 100 in the event of a power failure. Another POTS splitter 34 is maintained preferably within or nearby CPE 2. For each subscriber line, two POTS splitters are employed. One is in POTS splitter rack 27 and one is in POTS splitter (34) in the CPE 2. Central office 100 includes a battery 101 to provide power to central office 100 in the event of a power failure.

The ATM cell data with VPI/VCI matching that of the end user's Ethernet is extracted and delivered to an Ethernet transceiver for delivery to the port. DSLAM 9 demodulates data from multiple DSL modems and concentrates the data onto the ATM backbone network for connection to the rest of the network. DSLAM 9 provides back-haul services for package, cell, and/or circuit based applications through concentration of the DSL lines onto ATM outputs to the ATM switch 10.

The ATM switch 10 is the backbone of the ATM network. The ATM switch 10 performs various functions in the network, including cell transport, multiplexing and concentration, traffic control and ATM-layer management. Of particular interest in the system domain 100, the ATM switch provides for the cell routing and buffering in connection to the DSLAM 9, network control system (NCS) 11, video server 16 (e.g., a video distribution system for delivering videos over the network) and the Internet gateway (Internet Protocol IP router 13 and DSL terminator 12), and T1 circuit emulation support in connection with the multiple telephony links switch 15. A T1 circuit provides, for example, 24 voice channels packed into a 193 bit frame transmitted at 8000 frames per second. The total bit rate is 1.544 Mbps. The unframed version, or payload, includes 192 bit frames for a total rate of 1.536 Mbps.

The ATM switch 10 is shown coupled to a program guide server/video server 16 (for providing program guides and videos to users) to satellite 17, radio broadcast 18 or cable 19 networks. The ATM switch 10 is also coupled over the DSL terminator 12 and IP router 13 pair to receive Internet Protocol IP packet data from the Internet 14. These devices and implementations may be employed as is known in the art.

The network control system 11 provides for address translation, demand assignment and call management functions. One of network control system's functions is to manage the DSL/ATM network including the origination and termination of phone calls. The NCS 11 is essentially the control entity communicating and translating control information between a class 5 PSTN switch (using the GR-303 protocol) and the CPE 2. The network control system 11 is available for other functions such as downloading code to the CPE 2, and bandwidth and call management functions, as well as other service provisioning and set up tasks.

Telephones 3-6 preferably provide voice over DSL (VoDSL) service. In this case, analog voice signals will be provided from CPE unit 2 to the appropriate telephones with VoDSL service. In the event of a power failure, CPE unit 2, which is typically remotely located from CO 100 and employs the normal power grid as its power source, will lose power. This power loss will render VoDSL subscribers without voice phone service.

In accordance with the present invention, in the event of a power failure, the DSL CPE unit 2 will switch all or some phone lines to POTS. During a power failure, the DSL modem will not be able to operate. Therefore, the VoDSL service will not be available. The traditional POTS line is powered by the central office (CO) 100 through battery system 101 and therefore is capable of operating and still providing telephone service to the consumer. POTS splitters in rack 27 supply POTS through the network to provide analog service to telecommunications devices at the customer locations. The present invention provides an apparatus and method for switching to POTS in the event of a power failure.

In addition, when power has been re-instated while a consumer is using the POTS connection on the phone interface, it will not be switched back to VoDSL until the phone call has been completed. Otherwise interruption of the call will occur. This can be done by, for example, monitoring line current (on an individual basis).

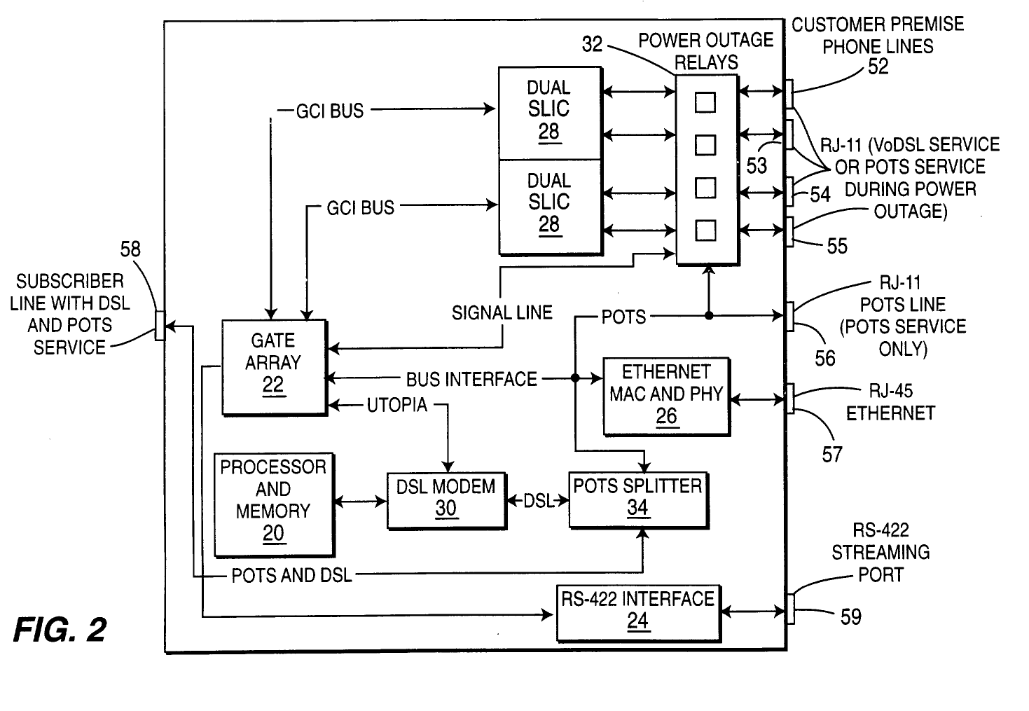

Referring to FIG. 2, a block diagram is shown for an illustrative DSL CPE unit 2 in accordance with one embodiment of the present invention. Unit 2 includes a plurality of phone interfaces 52-55 (for Customer Premise Phone Lines), which preferably include RJ-11 connectors. Other ports, such as port 56 (POTS Customer Premise Interface) may provide POTS service, an Ethernet connection 57 (e.g., using an RJ-45 connector), an asymmetric DSL (or ADSL line) subscriber line 58 with DSL and POTS service and/or a streaming port 59 (e.g. RS-422 port). Other ports and configurations are also possible. CPE unit 2 employs a processor and memory in block 20 to provide control for the various hardware and software functions provided by CPE unit 2. For example, processor and memory in block 20 provide multiplexing and demultiplexing operations for the plurality of devices on CPE unit 2 using gate array 22.

Each port connects to an interface circuit which controls the data flow through the respective port. Streaming port 58 connects to an RS-422 interface circuit 24. Ethernet port 57 connects to an Ethernet physical layer and medium access control (MAC) interface circuit 26, known to those skilled in the art. DSL line 58 is coupled to a DSL modem 30, and phone interfaces 52-55 are coupled to Subscriber Line Interface Circuits (SLICs) 28 through power outage relays 32 in accordance with the present invention.

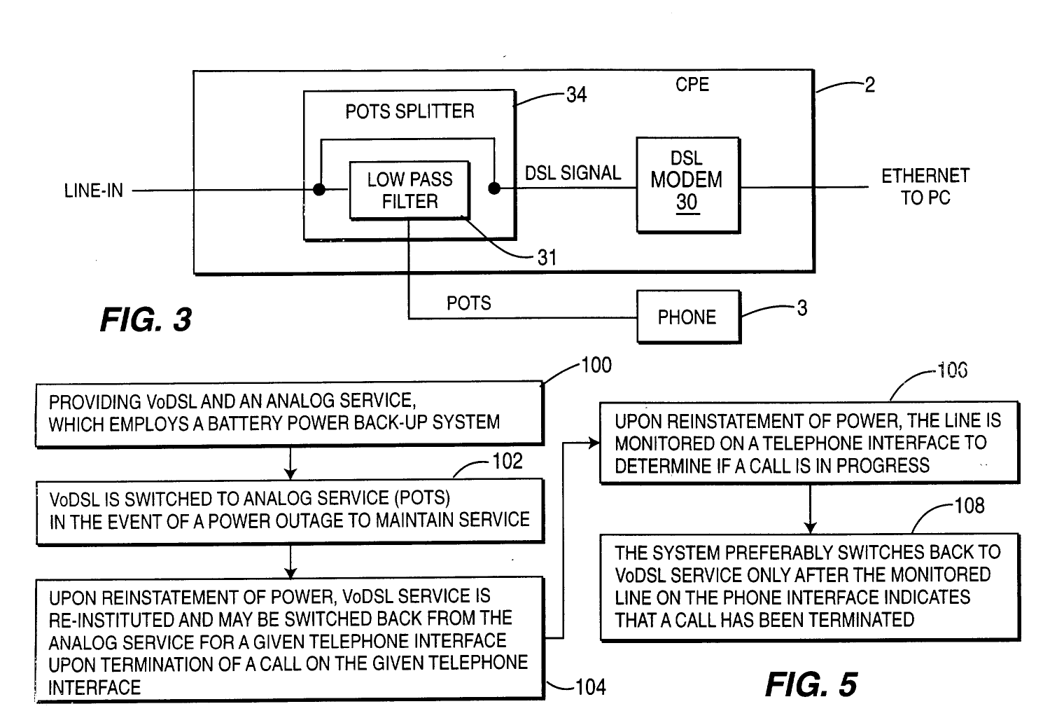

The DSL or ADSL line is connected through a POTS splitter 34 which will provide POTS service to line 56 and to relays (32) to switch VoDSL service to POTS service in the event of a power failure in accordance with the present invention. A signal line 36 may be employed to control relays 32 to switch between VoDSL and POTS service depending on the power failure status and whether or not a telephone call is in progress when switching VoDSL service back on. FIG. 3 shows an illustrative case for DSL employing POTS splitter 34. POTS splitter 34 may reside inside or outside of CPE 2, preferably inside CPE 2. POTS splitter 34 includes a low pass filter 31, which filters frequencies below 10 kHz, which are used by POTS. The higher DSL modem frequencies (e.g., 25 kHz to 1.1 MHz for ADSL) are usually passed unfiltered.

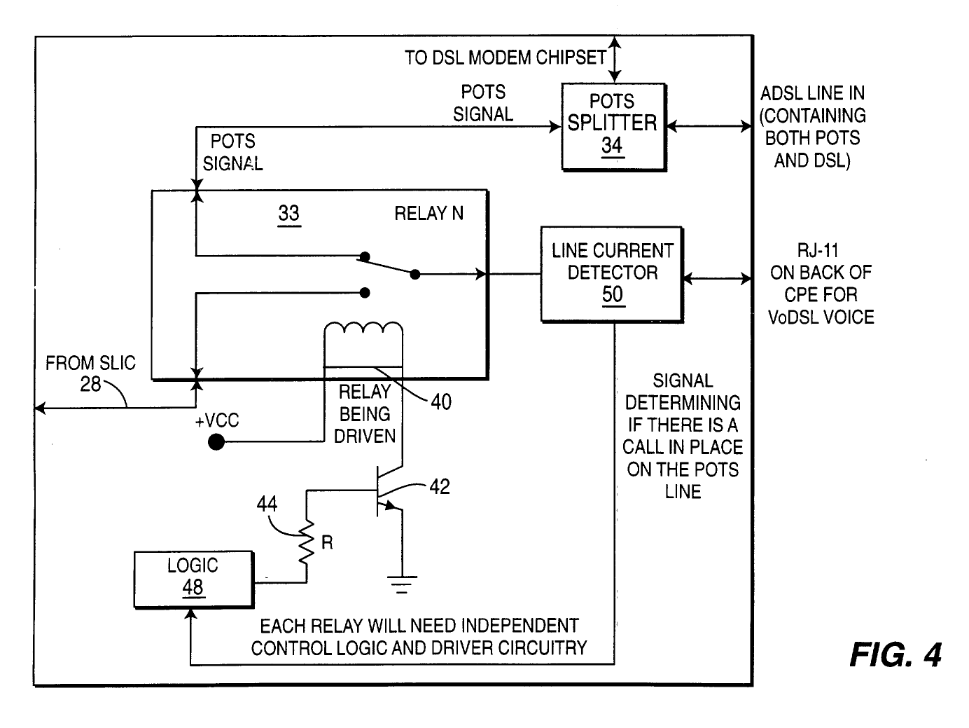

Referring to FIG. 4, an example of an individual relay 33 within the bank of relays 32 (FIG. 2) is illustratively shown. Relay 33 is shown in a powered on state and is therefore in the state where the output RJ-11, e.g. port 52 is connected to the Subscriber Line Interface Circuit (SLIC) 28 to enable the customer to use a VoDSL line. Relay 33 is driven by an appropriate relay driving circuit 36 which may include, for example, a relay coil 38 for relay 33, a diode 40, a transistor 42 and a resistor 44 to actuate relay switch 46. Each relay 33 is controlled by a logic circuit 48 that is signaled by microprocessor 20 (FIG. 2) or an integrated circuit or other device that has received a signal from a line current detection circuit 50. Relay coil 38 is energized by a supply voltage Vcc.

Line current detection circuit 50 sends a signal to logic 48 to control relay 33. In the event of a power failure, logic circuit 48 and relay coil 38 will be de-energized. This will move relay switch 46 to a power off state to enable POTS service by connecting switch 46 to POTS splitter 34. In this way, POTS service is made available to the VoDSL phone interface during the power failure. Each relay 33 is associated with independent driver circuitry and control logic 48.

Advantageously, during power-up of the CPE unit 2, if the line current detection circuit 50 detects line current, then relay 33 will not be connected to the SLIC 28 until the absence of line current has been detected. The signal generated by the line current detector 50 therefore indicates that the service line is in use at power-up (power reinstatement). In this way, uninterrupted telephone service is provided using POTS on the VoDSL phone interface. When the call is terminated after power-up, line current detector 50 will indicate to logic 48 that the phone has been hung-up. Logic 48 will then activate relay 33 which will switch back to providing VoDSL service.

Line current detector 50 may include a comparator circuit, which may include a differential amplifier, which compares the line voltage to a reference to determine whether the telephone line is in use. Alternately, an opto-isolator can be used to detect the line current directly.

In the event of a power outage, all or some of the VoDSL lines will be switched to the POTS line. This will make the switched phone ports on the CPE unit 2 common to each other. In the event of the power being re-instated (same as power-up condition), each connection of the telephone lines will be switched back intelligently to the SLIC interface (e.g., VoDSL lines) based upon the signal from its own line current detection circuit 50. The signal from the line current detection circuit 50 will identify if there is a call in progress on that particular line. If there is a call in progress, then the system will not interrupt the call by immediately switching back to the VoDSL line. It will wait for the absence of line current to switch back. Accordingly, an intelligent switching control mechanism is provided in accordance with the present invention, which ensures uninterrupted telephone service during a power outage for phone or devices connected to VoDSL phone interfaces.

Referring to FIG. 5, a method for maintaining phone service on a digital subscriber line during a power failure or other event includes providing a voice over digital subscriber line (VoDSL) for transmission of information and an analog service, which employs a battery power back-up system, in block 100. The VoDSL is switched to analog service (POTS) in the event of a power outage to maintain telecommunication service of the VoDSL during the power outage in block 102. This switching is preferably intelligently done so that even after power-up the calls in progress remain uninterrupted.

In block 104, upon reinstatement of power, VoDSL service is re-instituted. After the power outage, the VoDSL service may be switched back from the analog service for a given telephone interface upon termination of a call on the given telephone interface.

Upon reinstatement of power, the step of monitoring current on a telephone interface to determine if a call is in progress may be performed in block 106, and the system preferably switches back to VoDSL service only after the line current on the phone interface indicates that a call has been terminated in block 108. The digital subscriber line is may be an asymmetric digital subscriber line (ADSL).

Having described preferred embodiments for digital subscriber line feature for enabling plain old telephone service on customer premise phone lines of a VoDSL system in the event of a power failure (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method for maintaining voice service on digital subscriber line (DSL) system customer premise equipment, comprising the steps of:
providing customer premise equipment for transmission of information to and from a customer location;
providing an analog service which employs a battery power back-up system; and
switching a voice over DSL (VoDSL) phone interface on the customer premise equipment to the analog service in the event of a power outage to maintain telecommunication service on a customer premise equipment phone interface during the power outage.

2. The method as recited in claim 1, further comprising the step of switching to VoDSL service upon reinstatement of power.

3. The method as recited in claim 1, further comprising the step of: after the power outage, switching back to the VoDSL service from the analog service for a given telephone interface upon termination of a call on the given telephone interface.

4. The method as recited in claim 1, further comprising the step of upon reinstatement of power, monitoring current on a telephone interface to determine if a call is in progress.

5. The method as recited in claim 4, further comprising the step of upon reinstatement of power, switching back to VoDSL service after the line current on the phone interface indicates that a call has been terminated.

6. The method as recited in claim 1, wherein the digital subscriber line is an asymmetric digital subscriber line.

7. An apparatus for maintaining phone service on digital subscriber line (DSL) system customer premise equipment, comprising:
a digital service unit coupled to an analog service system, the digital service system providing voice over digital subscriber line (VoDSL) service to a user, the analog service system providing analog service with a battery back-up capable of delivering power during a power outage; and
a relay coupled to the analog service system and the VoDSL service unit to enable a telephone interface with one of analog service and VoDSL service responsive to a power outage.

8. The apparatus as recited in claim 7, wherein the analog service system is employed for the telephone interface during the power outage to ensure service on the telephone interface.

9. The apparatus as recited in claim 8, further comprising a line current detector coupled to a customer premise equipment, the line current detector for determining whether the telephone interface is in use during reinstatement of power after a power outage to ensure service on the telephone interface.

10. The apparatus as recited in claim 9, wherein the line current detector provides a signal to a logic circuit to indicate that the telephone interface is in use after reinstatement of the power, the logic circuit for disabling the relay to maintain analog service until the telephone interface is no longer in use.

11. The apparatus as recited in claim 7, wherein the relay is included in the digital service unit.

12. The apparatus as recited in claim 7, further comprising a plain old telephone service (POTS) splitter disposed within the digital service unit.

13. The apparatus as recited in claim 7, further comprising a plain old telephone system (POTS) splitter disposed at a central office for supplying digital service and plain old telephone service (POTS) to the digital service unit.
